(19) United States
(12) Patent Application Publication
(10) Pub. No.: US 2022/0346588 A1
(43) Pub. Date: Nov. 3, 2022

(54) Kitchen device making the poaching of eggs easier and safer

(71) Applicant: Richard Charles Hampson, Newtown, CT (US)

(72) Inventor: Richard Charles Hampson, Newtown, CT (US)

(21) Appl. No.: 17/733,119

(22) Filed: Apr. 29, 2022

Related U.S. Application Data
(60) Provisional application No. 63/183,345, filed on May 3, 2021.

(51) Int. Cl. A47J 29/06; A47G 21/04

(52) U.S. Cl. CPC A47J 29/06; A47G 21/04

(57) ABSTRACT

Kitchen device comprising three connected parts, an inverted dome cup, an attached spout and an attached handle, which makes poaching eggs easier and safer. The spout and handle are used as arms and have flat bases so that the device can suspend across a bowl. This allows for an egg to be cracked into the inverted dome cup so unwanted messy thin egg white is removed from the surface of the egg first before poaching, through integrated slits in the cup around the handle. The remaining thick egg white and yolk can then be poured safely via the spout directly into boiling water for cooking, keeping the users hands well above the hot water level.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCING TO SEQUENCING LISTING, A TABLE, OR COMPUTER PROGRAM LISTING COMPACT DISC APPENDIX

Not applicable.

### BACKGROUND OF INVENTION

Kitchen device which makes the poaching of hens eggs easier and safer, overcoming common challenges faced by domestic and professional cooks. Poaching eggs freely in boiling water should be easy but four main challenges exist, which lead to the egg whites and yolks separating during the cooking process and the cook being exposed to being burnt by boiling water.

Firstly, eggs contain both thick and thin egg white, with thick egg white being attached to the yolk and thin egg white loose, surrounding the rest of the egg. If not removed before poaching, thin egg white detaches when an egg is cracked into simmering/boiling water. This creates unwanted residual egg white mess floating in the pan and the perception that eggs are difficult to poach, discouraging people from making them.

Secondly, egg white viscosity declines over time once an egg is laid, with older eggs containing more thin egg white than fresh eggs. For most consumers of eggs bought through a supermarket distribution system, this process is well under way making the perceived poaching process even harder.

Thirdly, an egg faces upward resistance forces when cracked into boiling water, transitioning through the air into liquid. These forces stress the thin egg white, thick egg white and yolk in different magnitudes due to their different densities, forces which encourage the egg whites and egg yolk to separate into unwanted poached egg forms.

Fourthly, when an egg is cracked directly into simmering/boiling water from above, there is a risk of the cook being burnt due to the proximity of hands to hot steam and the potential of splashback from the boiling water as the egg drops into it under gravity.

The invention provides an elegant solution to all four of these challenges in a single handheld kitchen device. The invention falls within patent classification definitions of kitchen equipment and more specifically across implements for preparing or holding food; cooking spoons; ladles and devices for opening raw eggs or separating the contents thereof.

### BRIEF SUMMARY OF THE INVENTION

Handheld kitchen device to simplify and make safer the poaching of hens eggs freely in simmering/boiling water through unique multi purpose design which can remove thin egg white from the thick egg white and yolk desired for poaching in advance of cooking, before acting as a vessel to release the egg in a controlled manner directly into boiling water whilst keeping hands well above the heat of the pan for safety. This helps eggs retain their shape and hold together during the transition into water for poaching and reduces burning risk for the users.

The device is made up of three main design components, an inverted dome cup, an integrated spout and a handle. The design utilizes the spout and the handle, which are located opposite each other, either side of the inverted dome cup, as arms to allow the user to suspend the inverted dome cup component when placed across a bowl. This is a key feature in enabling the user to remove thin egg white in advance of poaching an egg. The spout and handle cross the rim of the bowl providing balance and both have flat bases to create stability. With the utensil placed across a bowl it allows for the user to crack an egg into the inverted dome cup in advance of poaching. A collection of horizontal slits cut into the inverted dome cup around the handle subsequently allow thin egg white to pass through and escape into the bowl below but retain the thick egg white and yolk in the holding cup wanted for poaching.

The user can then transfer the egg yolk and thick egg white within the inverted dome cup to a pan of boiling water by lifting the handle, and then tipping the egg directly into boiling/simmering water, through the integrated spout by tilting the device towards the spout. The spout can be submerged under the water level which removes the velocity disruption changes which normally occur when cracking an egg freely from above the water level into it. The controlled release of the egg and removal of the thin egg white maximize the likelihood the user creates a well formed poached egg.

The handle keeps the users hand well above the hot water level at all times and is therefore safer than cracking an egg directly into the hot water.

Once cooked to the users liking, the poached egg can also be removed from the water using the same device.

### BRIEF DESCRIPTION OF THE SEVERAL DRAWINGS

FIG. 1 shows the side view of the kitchen utensil, illustrating a substantially inverted dome cup 1, an attached spout 2, with a horizontal protrusion 5, an attached handle 3 and a group of substantially vertical slits positioned around the attached handle 4.

FIG. 2 shows the attached spout 2 centered opposite the attached handle 3.

FIG. 3 demonstrates the handheld kitchen device suspended across a bowl or similar using the attached spout 2 and attached handle 3 as balancing arms.

FIG. 4 illustrates a concave, halfpipe shaped attached spout 2.

FIG. 5 shows the handheld kitchen device from below, illustrating the flat base 6, to the attached spout 2.

FIG. 6 is a rear view of the handheld kitchen device, showing the substantially flat base 7 to the attached handle 3.

### DETAILED DESCRIPTION OF THE INVENTION

Manufactured handheld kitchen device to simplify and make safer the poaching of hens eggs freely in simmering/boiling water, which can be used in both the domestic and professional kitchen. The device overcomes the biggest challenges faced when poaching eggs, keeping the egg yolk and egg white combined together in a single form and not to burn hands when cracking an egg from close proximity above simmering/boiling water. The device can be manufactured through injection molding using food grade silicone or similar food grade plastic materials like nylon, common in kitchen utensil production.

For most people, eggs are bought through a supermarket distribution system, which lengthens the time between being laid and consumption. Eggs are made up of a yolk, thick egg white which is attached to the yolk and thin egg white. Over time thick egg white deteriorates and becomes less viscous, increasing the amount of thin egg white contained in the egg. This thin egg white, if cracked directly into a pan of simmering/boiling water, separates from the egg and creates unwanted egg white mess, making poaching difficult, which puts people off doing so. To simplify the poaching of eggs, thin egg white either needs to be removed or contained and the egg needs to be gently submerged in hot water to prevent any further separation of the egg.

Other devices have been invented to overcome egg poaching challenges by providing some sort of cradle or containment in which the cracked egg sits and is cooked, to prevent separation. The kitchen device is not a containment device as it is designed to release the egg to cook freely in simmering/boiling water.

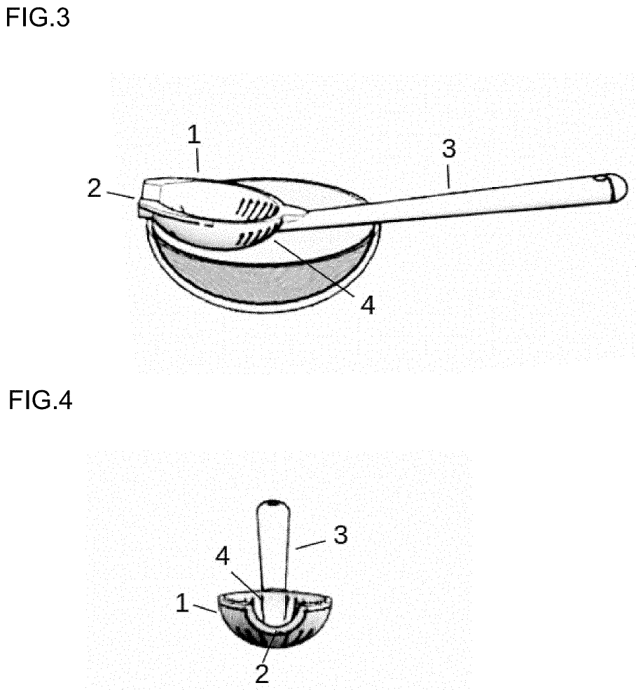

The kitchen device differentiates from other cooking spoons or ladles, which are principally designed to scoop up food stuffs from below and serve. It is specifically designed so that it will suspend over a bowl FIG. 3 so an egg can be cracked into a inverted dome cup 1, from above before poaching, not scoop up food stuffs from below, although the user may use the device to remove a poached egg from a pan if they choose.

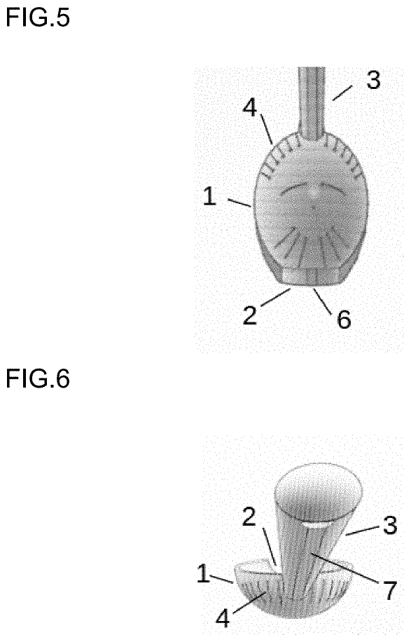

The device is also differentiated from other spoons or ladles, by the spout 2, with a horizontal protrusion 5 from the inverted dome cup 1 and a flat base FIG. 5, 6, used as an arm to balance the device, when placed over a bowl. The spout has a halfpipe shape FIG. 4 of dimensions to allow an egg yolk to pass through with minimum disruption. The attached handle 3, acts as the other balancing arm when placed over a bowl FIG. 3 and also has a substantially flat base 7, for stability when placed over a bowl. The flat base to the attached handle 3 runs for most of the length of the attached handle FIG. 6 to provide flexibility over the size of bowl the device is placed over.

The device further differentiates from other inventions which separate solids from liquids and devices for separating raw eggs. The inverted dome cup has a group of substantially vertical slits 4, located around the attached handle 3, specifically inserted to allow for thin egg white only, which rises to the top of the egg when cracked into the inverted dome cup 1, due to its lower density, to pass through, retaining the thick egg white and yolk wanted for poaching. Egg separation devices are designed to remove all the egg white, not leave the thick egg white behind. Other strainers or separators of food stuffs inventions are similarly not designed with the horizontal, specific slit dimensions and or positioning required to remove thin egg white at the surface from thick egg white and the yolk, differentiating the device from other food strainers.

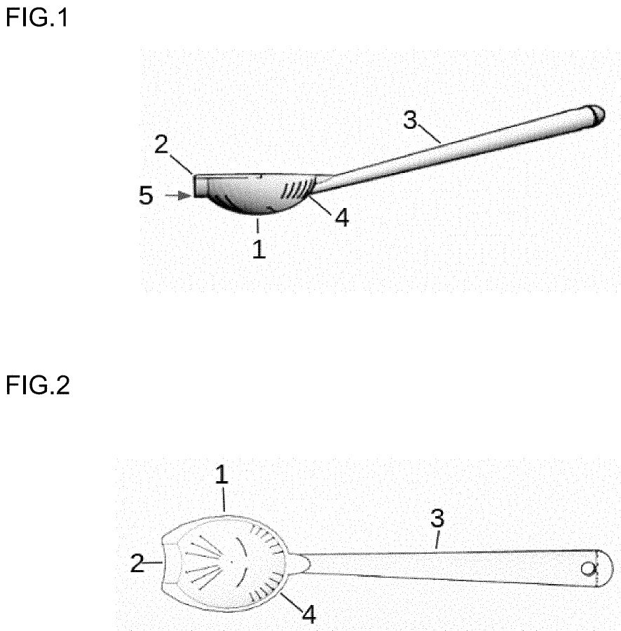

The handheld device is made up of three main design components, an inverted dome cup 1, a spout 2 and a handle 3 integrated together FIG. 1. The inverted dome cup 1 promotes less dense thin egg white to rise to the surface of an egg when it has been cracked into it. The inverted dome cup is oval in shape mimicking the natural shape of an egg, which helps facilitate the removal of the thin egg white through the slits 4, as the thin egg white passes over the top of the egg towards the handle 3. The thin egg white moves towards the handle as when the utensil is placed over a bowl FIG. 3 the holding cup sits at a slight negative angle to the horizontal.

The device uses the attached spout 2 and the attached handle 3, as arms to allow the user to suspend the holding cup component across a bowl FIG. 3. The attached handle and attached spout are positioned opposite each other FIG. 2. The spout and handle cross the rim of the bowl FIG. 3 providing balance. The spout has a flat base 6 for stability. With the utensil placed across a bowl it suspends the inverted dome cup 1, for the user to crack an egg into it and remove the thin egg white into the bowl below, retaining the thick egg white and yolk in the holding cup wanted for poaching. The handle has a substantially flat base 7 also for stability and flexibility to suspend over a range of bowl sizes.

Once thin egg white has been removed, the user can transfer the egg yolk and thick egg white within the inverted dome cup 1, to a pan of boiling water by lifting the handle 3, and then tipping the egg directly into boiling/simmering water, through the attached spout 2, by tilting the device towards the spout. The spout can be submerged under the water level which removes the velocity disruption changes which normally occur when cracking an egg freely from above the water level into it. The spout has a straight outer edge, which creates a defined lip over which the egg yolk and attached thick egg white pass easily which helps prevent the breakup of the egg. The spout is substantially halfpipe in shape FIG. 4 with a width which creates a channel through which an egg yolk will pass through without being damaged/punctured. The channeled controlled release of the egg which the spout creates and removal of the thin egg white, maximize the likelihood the user cooks a well formed poached egg.

The handle 3, keeps the users hand well above the hot water level at all times and is therefore safer than cracking an egg directly into the hot water.

Once cooked to the users liking, the poached egg can also be removed from the water using the same utensil where other slits cut within the holding cup will drain off water.

1. A kitchen device comprising: a substantially inverted dome cup member; a spout member secured to said substantially inverted dome cup member; and a handle member secured to said substantially inverted dome cup member.

2. A kitchen device as in claim 1, wherein said substantially inverted dome cup member has a group of substantially vertical slits, positioned around said handle member.

3. A kitchen device as in claim 1, wherein said handle member has a substantially flat base.

4. A kitchen device as in claim 1, wherein said spout member has a position centered opposite the said handle member.

5. A kitchen device as in claim 1, wherein said spout member has a horizontal protrusion from said substantially inverted dome cup cup member.

6. A kitchen device as in claim 5, wherein said spout member has a substantially concave halfpipe shape.

7. A kitchen utensil as in claim 6, wherein said spout member has a flat base.
